(19) United States
(12) Patent Application Publication
(10) Pub. No.: US 2010/0233543 A1
(43) Pub. Date: Sep. 16, 2010

(54) NONAQUEOUS SECONDARY BATTERY

(76) Inventors: Koichi Numata, Ageo-shi (JP); Takashi Okamoto, Ageo-shi (JP); Hitohiko Ide, Ageo-shi (JP); Yasunori Tabira, Ageo-shi (JP); Akihiro Modeki, Ageo-shi (JP)

Correspondence Address: YOUNG & THOMPSON, 209 Madison Street, Suite 500, Alexandria, VA, 22314, US

(21) Appl. No.: 12/377,732

(22) PCT Filed: Sep. 28, 2007
(86) PCT No.: PCT/JP2007/069087

§ 371 Date: Feb. 17, 2009

(30) Foreign Application Priority Data
Sep. 29, 2006 (JP) 2006-266161
May 10, 2007 (JP) 2007-126164
Sep. 28, 2007 (JP) 2007-255910

(51) Int. Cl. H01M 4/50; H02J 7/04; H02J 7/00

(52) U.S. Cl. 429/224; 320/162; 320/134

(57) ABSTRACT

A nonaqueous secondary battery comprising a positive electrode which has a positive electrode active material layer containing Li(LiₓMn₂ₓCo₁₋₃ₓ)O₂ wherein x represents 0<x<⅓, and a negative electrode which has a negative electrode active material layer containing Si or Sn. The amounts of the active materials are preferably such that the ratio of the theoretical capacity of the negative electrode to the capacity of the positive electrode at a cut-off voltage in a first and subsequent charging operations is 1.1 to 3.0. The battery preferably has lithium corresponding to 9% to 50% of the theoretical capacity of the negative electrode accumulated in the negative electrode.

### TECHNICAL FIELD

This invention relates to a nonaqueous secondary battery, such as a lithium secondary battery.

### BACKGROUND ART

Graphite has been used as a common negative electrode active material of lithium ion secondary batteries. With the recent tendency to multifunctionality of electronic equipment, however, the power consumption of electronic equipment has shown a remarkable increase. The demand for higher capacity secondary batteries has therefore been increasing. As long as graphite is used, it would be difficult to meet the increasing demand in near future. Then negative electrode active materials comprising an Sn-based substance or a Si-based substance having high capacities than graphite have been under intensive development.

Nevertheless, Sn- or Si-based negative electrode active materials generally have a large irreversible capacity in the first charge. Therefore, in order to take advantage of the characteristics possessed by these active materials, it is necessary to use them in combination with positive electrode active materials having high capacity and also moderate irreversible capacity.

Applicant of the present invention previously proposed a positive electrode material for lithium secondary batteries represented by chemical formula: Li(LiₓMn₂ CO₁₋₃ₓ)O₂ (0<x<⅓), which is lithium cobalt oxide with cobalt substituted with manganese and lithium in accordance with 3 Co³⁺ [symbol] 2Mn⁴⁺+Li⁺ (see Patent Document 1). The proposed positive electrode material has the advantage of improving charge/discharge cycle characteristics. The battery of Patent Document 1 does not involve the above-described problem of irreversible capacity loss in the first charging operation because the negative electrode material used in combination with the positive electrode material is metallic lithium. Therefore, Patent Document 1 gives no information about the effect produced when the positive electrode material proposed therein is combined with an Sn- or Si-based negative electrode material. Seeing that the Li(LiₓMn₂ₓ Co₁₋₃ₓ)O₂ has lower capacity than LiCoO₂ and the like that have commonly been used as a positive electrode active material, it has not been conceived to combine the Li(LiₓMn₂ₓ Co₁₋₃)O₂ with an Sn- or Si-based negative electrode active material that has been developed in an attempt to obtain high capacity batteries.

Patent Document 1 JP 8-273665A

### DISCLOSURE OF THE INVENTION

The present invention is contemplated to provide a nonaqueous secondary battery that takes full advantage of the high capacity characteristics possessed by an Sn-based or Si-based negative electrode active material.

The invention provides a nonaqueous secondary battery comprising a positive electrode which has a positive electrode active material layer containing Li(LiₓMn₂ₓ CO₁₋₃ₓ)O₂ wherein x represents 0<x<⅓, and a negative electrode which has a negative electrode active material layer containing Si or Sn.

The invention also provides a method of conditioning a nonaqueous secondary battery, wherein the battery contains a positive electrode active material and a negative electrode active material in such amounts that the ratio of the theoretical capacity of the negative electrode to the capacity of the positive electrode at a cut-off voltage in a first and subsequent charging operations is 1.1 to 3.0 and the battery is adapted to be subjected to charge and discharge cycles such that the negative electrode capacity at the cut-off voltage in the first and subsequent charging operations is ranging from 0% to 90% of the theoretical capacity of the negative electrode; and
wherein the method comprises supplying to the negative electrode lithium of an amount corresponding to 50% to 90% of the theoretical capacity of the negative electrode prior to the charge and discharge cycles.

### BRIEF DESCRIPTION OF DRAWINGS

FIG. 1 is plots of XAFS spectra of Li(Li_{0.03}Mn_{0.06} Co_{0.91})O₂ and LiCoO₂ showing their behavior as a positive electrode active material in a battery at the time of charge.

FIG. 2 is plots of XAFS spectra of Li(Li_{0.2}Mn_{0.4} Co_{0.4})O₂ showing its behavior as a positive electrode active material in a battery at the time of charge.

FIG. 3 is a schematic cross-section of an embodiment of a negative electrode used in the nonaqueous secondary battery of the invention.

FIGS. 4(a) to 4(b) are diagrams showing a process of producing the negative electrode shown in FIG. 3.

FIG. 5 shows charge/discharge curves obtained when the batteries of Examples 4 and 7 were subjected to preliminary charge and subsequent discharge.

### BEST MODE FOR CARRYING OUT THE INVENTION

The present invention will be described based on its preferred embodiments. The nonaqueous secondary battery according to the invention (hereinafter also referred simply to as a secondary battery or, more simply, a battery) basically includes a positive electrode, a negative electrode, and a separator disposed therebetween. A nonaqueous electrolyte fills between the positive and the negative electrodes through the separator. The shape of the battery of the invention having these components is exemplified by, but not limited to, a cylinder, a rectangle, and a coin.

The positive electrode that can be used in the battery of the invention is composed of for example, a current collector and a positive electrode active material layer formed on at least one side of the current collector. The positive electrode active material layer contains an active material. In the present invention a specific lithium-transition metal complex oxide is used as the positive electrode active material. The specific lithium-transition metal complex oxide is represented by formula (I):

Li(LiₓMn₂ₓCO₁₋₃ₓ)O₂ (1)

where x represents 0<x<⅓, preferably 0.01≦x≦0.2, more preferably 0.03≦x≦0.1.

The lithium-transition metal complex oxide represented by formula (1) (hereinafter simply referred to as lithium-transition metal complex oxide (1)) corresponds to a compound derived from lithium cobalt oxide (LiCoO₂), a layer compound, by displacing the cobalt with manganese and lithium in accordance with 3 Co³⁺ [symbol] 2Mn⁴⁺+Li⁺, thereby to provide a stabilized host structure. In detail, displacement of trivalent cobalt with tetravalent manganese provides a lithium-transition metal complex oxide (1) the crystal lattice of which shows reduced expansion and contraction with intercalation and deintercalation of lithium ions. The mechanism will be explained later.

The present inventors' further investigations have revealed that the lithium-transition metal composite oxide (1) provides a battery having an increased charge/discharge capacity and an increased irreversible capacity in the first charge when it is combined with a Si or Sn negative electrode active material, which has higher capacity than graphite, and when the resulting battery is charged at a higher cut-off voltage than that used for conventional lithium secondary batteries. Thus, the combination makes it possible to provide a battery with a high capacity and a long life as will hereinafter be described in detail.

In the present invention, the cut-off voltage in preliminary charge is set high, whereby part of the crystal structure of the lithium-transition metal complex oxide (1), a positive electrode active material, is destroyed, and part of the lithium contained therein is supplied to the negative electrode active material. Part of the thus supplied lithium is accumulated in the negative electrode active material as an irreversible capacity. Therefore, the charge/discharge cycle after the preliminary charge starts from the state in which the negative electrode has lithium absorbed. This makes it possible to carry out subsequent charge/discharge cycles almost completely reversibly. This is because the sites of the negative electrode active material that stably alloy with lithium are used preferentially for lithium absorption in the preliminary charge, so that, in the second and subsequent charging operations, lithium are to be absorbed in sites that easily absorb and release lithium. To charge a negative electrode active material having lithium absorbed therein means to create the same state as the state wherein the negative electrode active material has lithium absorbed before it is assembled into a battery. To create such a state of the negative electrode active material having lithium absorbed therein before being assembled into a battery provides a very significant advantage of easy and highly productive absorption of lithium into the negative electrode active material. For these reasons, prolongation of battery life can be achieved. As used herein, the term “preliminary charge or preliminary charging” denotes the first charging operation conducted after battery assembly, which is generally given by battery manufacturers before shipment from the factory to market for the purpose of safety and operation check. In other words, commercially available lithium secondary batteries usually have previously been subjected to preliminary charge. Accordingly, the first charging/discharging operation conducted after the preliminary charge and the discharge subsequent to the preliminary charge can be said to be the first charging/discharging operation. In this sense, “the charging/discharging operations after the discharge subsequent to the preliminary charge” will hereinafter be referred to as “the first and subsequent charging/discharging operations”.

The amount of irreversible capacity is preferably such that the accumulated amount of part of lithium supplied from the lithium-transition metal complex oxide (1) that is not returned to the positive electrode by discharge is 9% to 50%, more preferably 9% to 40%, even more preferably 10% to 30%, of the theoretical capacity of the negative electrode active material. To define the upper limit of the accumulated amount of lithium in the negative electrode active material at 50% of the theoretical capacity of the negative electrode active material makes it feasible to maintain the usable capacity of the negative electrode active material in the first and subsequent charge/discharge cycles, to suppress reduction of volumetric energy density due to expansion of the negative electrode active material, and to obtain sufficiently increased energy density compared with a conventional carbon negative electrode active material. When, in particular, the upper limit is lowered to 30%, there is provided, in addition to the advantages relating to energy density, a better balance between the amount of lithium released from the positive electrode active material in the preliminary charge/discharge and the amount of lithium that moves between the positive and the negative electrodes in the charging and discharging operations after the preliminary charge. By making the balance, a sufficient amount of lithium reversibly moves between the positive and the negative electrodes in charge/discharge cycles after the preliminary charge. It should be noted that supplying too much lithium to the negative electrode active material in the preliminary charge tends to result in reducing the amount of lithium reversibly moving between the positive and the negative electrodes in charge/discharge cycles after the preliminary charge. The term “irreversible capacity” as used herein means the capacity obtained by subtracting the capacity corresponding to the amount of lithium that moves from a negative electrode to a positive electrode in the discharge subsequent to the preliminary charge from the capacity corresponding to the amount of lithium that moves from the positive electrode to the negative electrode in the preliminary charge.

In connection to the irreversible capacity, it is preferred that the amount of lithium supplied from the positive to the negative electrode in the preliminary charge is 50% to 90% of the theoretical capacity of the negative electrode active material in view of the amount returned to the positive electrode by discharge. When the preliminary charge is performed to such an extent, sites that stably alloy with lithium are easily formed throughout the negative electrode active material by the preliminary charge, which promises that the whole negative electrode active material and eventually almost the entire area of the negative electrode active material layer is capable of easily and evenly absorbing lithium in the first and subsequent charging operation. As used herein, the term “theoretical capacity of a negative electrode” refers to the discharge capacity obtained when a dipole cell having lithium as a counter electrode is charged to 0 V, followed by discharging to 1.5 V. In order to increase reproducibility in the measurement of the theoretical capacity of a negative electrode active material, it is preferred that the charging operation is in a constant current mode at a rate of 0.05 C, that the constant current mode is changed to a constant voltage mode when the cell voltage reaches 0 V, and the charging is continued until the current reduces to ⅕ that in the constant current mode. For the same purpose the discharging is preferably performed in a constant current mode at a rate of 0.05 C. The term “theoretical capacity of the positive electrode” as used herein in connection with the theoretical capacity of the negative electrode refers to a value as measured by the following method. A coin battery is made using the positive electrode prepared in Example 1 given infra and an elemental lithium negative electrode according to the method of Example 1. The battery is charged and discharged under the following conditions, and the resulting discharge capacity is taken as the theoretical capacity of the positive electrode.

Charge: at a constant current rate of 0.2 C (5 hour rate) up to a voltage of 4.3 V and then at a fixed voltage of 4.3 V up to the end when the current reduces to 1/10 the constant current.

Discharge: at a constant current of 0.2 C up to 3.0V.

To accumulate part of lithium in the negative electrode active material as irreversible capacity provides an additional advantage. That is, since the negative electrode active material has always lithium absorbed therein in every discharging operation after the preliminary charge, the negative electrode active material layer always has good electron conductivity, resulting in reduced polarization of the negative electrode. As a result, there is less likelihood of the negative electrode suddenly reducing the voltage in the final stage of discharge. This is especially advantageous when a Si-based material with low electron conductivity, particularly elemental Si is used as a negative electrode active material.

The lithium-transition metal complex oxide (1), a positive electrode active material, has a less destructible crystal structure than conventional positive electrode active materials, such as LiCoO₂, even at an increased charge cut-off voltage. Such a property is also called high voltage resistance. Thus, the secondary battery of the invention is permitted to be charged at a higher cut-off voltage than with the case of conventional batteries. To increase a charge cut-off voltage is very advantageous in that a battery may be designed to have a high capacity. Furthermore, since the lithium-transition metal complex oxide (1) has high voltage resistance, there is less likelihood that lithium released from the complex oxide is accumulated in the negative electrode active material as irreversible capacity with repetition of charge/discharge cycles after the preliminary charge. By this and previously described other effects, charge/discharges cycles after the preliminary charge can be achieved almost completely reversibly. It is acceptable that the lithium-transition metal complex oxide (1) contains unavoidable impurity as long as the effects of the present invention are exerted.

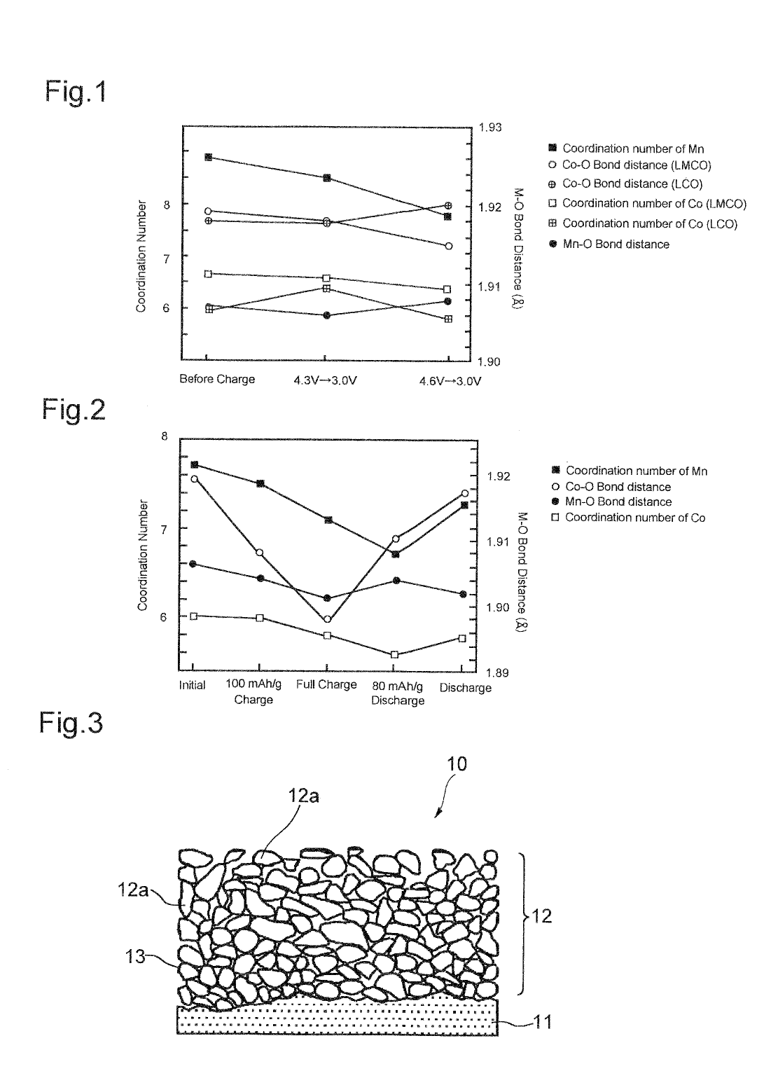

The fact that the lithium-transition metal complex oxide (1) has higher voltage resistance than conventional positive electrode active materials, such as LiCoO₂, is supported by, for example, the measurement results shown in FIG. 1. FIG. 1 presents the results of measurement on batteries assembled according to the procedure of Example 1 given later using a positive electrode prepared by using Li(Li_{0.03}Mn_{0.06} CO_{0.91})O₂ as a lithium-transition metal complex oxide (1) (hereinafter also referred to as LMCO) in the same manner as in Example 1 and a metallic lithium negative electrode. For comparison, FIG. 1 also shows the results of measurement on batteries in which LiCoO₂ (hereinafter referred to as LCO) is used in place of Li(Li_{0.03}Mn_{0.06} CO_{0.91})O₂. The measurement was made as follows. Each battery was preliminarily charged at a constant voltage of 4.6 V or 4.3 V and discharged to 3.0 V. Thereafter, the battery was disassembled, and the active material of the positive electrode was analyzed by XAFS to determine coordination number of Mn (i.e., coordination number of O around Mn, only for LMCO), Co—O bond distance, coordination number of Co (i.e., coordination of O around Co), and Mn—O bond distance (only for LMCO).

As is apparent from the results shown in FIG. 1, the coordination number of Mn for LMCO reduces with an increase of state-of-charge (SOC) in the preliminary charge. On the other hand, the coordination number of Co undergoes no change with an increase of SOC in the preliminary charge. This means that LMCO releases O around Mn in charging operation to create oxygen deficiency, by which to achieve electric charge compensation. As a result, the Co—O bond distance for LMCO reduces as the SOC increases. The reduction in Co—O bond distance results in an increased bond strength. LMCO is therefore less likely to be destroyed when the SOC is increased in the preliminary charge. This is the reason LMCO exhibits high voltage resistance. Thus, a secondary battery having LMCO as a positive electrode active material has excellent cycle characteristics. In contrast, the Co—O bond distance for LCO increases with an increase of SOC in the preliminary charge, resulting in reduced bond strength. LCO is therefore less resistant to voltage. For these reasons, it is very advantageous to use LMCO in combination with a negative electrode active material with high capacity, such as a Si- or Sn-containing active material.

The conclusion drawn from the results of FIG. 1 that “LMCO creates oxygen deficiency around Mn in charging operation to achieve electric charge compensation, and consequent reduction in Co—O bond distance results in an increased bond strength” is based on the premise that Mn undergoes no change in valency in charging operation. In order to test the premise, valence change of Mn and Co in LMCO during charge was determined by XAFS analysis. The results obtained are shown in FIG. 2. The measurement was made in the same manner as for the measurement of FIG. 1, except that Li(Li_{0.03}Mn_{0.06} Co_{0.91})O₂ as LMCO was replaced with Li(Li_{0.2}Mn_{0.4}O_{0.4})O₂ because the latter exhibits higher sensitivity in the measurement of coordination number of Mn and Mn—O bond distance than the former. The graph of FIG. 2 shows changes of coordination numbers of Mn and Co and Mn—O and Co—O bond distances in the LMCO while a battery is charged to full capacity and then fully discharged. The results in FIG. 2 reveal that Mn undergoes large and irreversible changes in coordination number in the charging and discharging operations, indicating the presence of oxygen deficiencies around Mn. The results also show no change in Mn—O bond distance, which indicates no change in Mn valency. In contrast, Co undergoes no change in coordination number in the charging and discharging operations, which shows that there is no oxygen deficiency around Co. It is also seen that the Co—O bond distance is the smallest in the fully charged state, which means that Co has undergone valency change, i.e., oxidation.

As a result of researches, the inventors have ascertained that 2x in formula (1), the coefficient indicative of the amount of Mn, is preferably in the range of 0.02≦2x≦0.4 (i.e., 0.01≦x≦0.2). With the amount of Mn falling within that range, the lithium-transition metal complex oxide has enhanced crystal structure strength (i.e., a shorter Co—O bond distance) to show increased voltage resistance, and evolution of quantities of oxygen gas resulting from oxygen deficiencies accompanying valency change of Mn is prevented. Evolution of quantities of oxygen gas should be averted because it leads to elevation of battery inner pressure.

In order to provide the secondary battery of the invention with high capacity and long life, it is preferred to control the charging conditions for the preliminary charge and the first and subsequent charging operations. With respect to the preliminary charge, the cut-off voltage is preferably set high so that lithium released from the lithium-transition metal complex oxide (1) may be accumulated in the negative electrode active material to constitute irreversible capacity. From this viewpoint, the cut-off potential in the preliminary charge is preferably 4.4 V or higher, more preferably 4.4 to 5.0 V, even more preferably 4.5 to 5.0 V, vs. Li/Li⁺. When the preliminary charge cut-off potential is lower than 4.4 V, the effect of accumulating lithium in the negative electrode active material as irreversible capacity would be insufficient.

With respect to the method of conditioning the secondary battery of the invention, in charging the secondary battery, it is preferred that the cut-off voltage of preliminary charge, the first charge which is performed after battery assembly, is higher than that in the charging operations after the preliminary charge. In other words, the cut-off voltage in the first and subsequent charging operations is preferably set lower than that used in the preliminary charge. It should be noted, however, that charging to too low a cut-off voltage is no more than charging under the same conditions for lithium secondary batteries using conventional positive electrode active materials, resulting in a failure to take full advantage of the lithium-transition metal complex oxide (1). Conversely, if the cut-off voltage is too high, the nonaqueous electrolyte is liable to damage. Accordingly, the cut-off potential in the first and subsequent charging operations is preferably 4.3 to 5.0 V, more preferably 4.35 to 4.5 V, vs. Li/Li⁺. As described in patent document 1 supra, conventionally used lithium secondary batteries have a working voltage between 3 V and 4.3 V. Applying a voltage higher than that range to the battery breaks the crystal structure of the positive electrode active material. Manufacturers of lithium secondary batteries strictly control the voltage by providing a battery with a protective circuit. Therefore, those in the art do not use a high voltage to improve cycle characteristics.

When the amounts of the positive and the negative electrode active material are decided so that the ratio of the theoretical capacity of the negative electrode to the capacity of the positive electrode at a cut-off voltage in the charging operations after the preliminary charge (hereinafter referred to as a negative/positive electrode capacity ratio) may be 1.1 to 3.0, preferably 2.0 to 3.0, and the preliminary charge is conducted at a higher voltage than the cut-off voltage for the first and subsequent charging operations to supply lithium corresponding to 50% to 90% of the theoretical capacity of the negative electrode from the positive electrode to the negative electrode, there is obtained an advantage that the whole negative electrode is activated. This advantage is unique to the use of a negative electrode containing a Si- or Sn-containing active material. By such a preliminary charging operation, the lithium supplied from the lithium-transition metal complex oxide (1) is accumulated in the negative electrode as irreversible capacity thereby to achieve the advantage described. With the negative/positive electrode capacity ratio being 1.1 or higher, lithium dendrite is prevented from occurring thereby securing battery safety. When the negative/positive electrode capacity ratio is 2.0 or higher, it is additionally possible to obtain sufficient capacity retention. With the negative/positive electrode capacity ratio being 3.0 or lower, the negative electrode capacity can be made full use of, leading to an improvement on battery energy density.

In the case when the negative/positive electrode capacity ratio is in the range recited, and the preliminary charge is carried out under the conditions recited, the first and subsequent charge and discharge cycles are preferably controlled so that the negative electrode capacity at the charge cut-off voltage ranges from 0% to 90%, more preferably from 10% to 80%, of the theoretical capacity of the negative electrode. That is, charge and discharge are performed within the range of from 0% (minimum) to 90% (maximum) of the negative electrode theoretical capacity, for example in the range of 20% to 60%. The upper limit of the charge being 90% of the negative electrode capacity, the active material is prevented from excessively expanding, whereby the cycle characteristics are improved. The negative electrode theoretical capacity being as defined above, the point 0% in the charge/discharge cycling corresponds to the discharge end point in the measurement of negative electrode theoretical capacity.

Charging operations are preferably performed in a constant current mode or a constant current/constant voltage mode as is usual with conventional lithium secondary batteries. The preliminary charge may be conducted in a constant current/constant voltage mode, while the first and subsequent charge operations are in a constant current mode.

Unlike the charging conditions, discharging conditions for the secondary battery of the invention are not critically influential on the battery performance, and conditions commonly used for conventional lithium secondary batteries are adopted. For example, the cut-off voltage of discharge is preferably 2.0 to 3.5 V, more preferably 2.5 to 3.0 V.

The lithium-transition metal complex oxide (1) is prepared conveniently by the following method. Starting materials to be used include a lithium salt, such as lithium carbonate, lithium hydroxide, or lithium nitrate; a manganese compound, such as manganese dioxide, manganese carbonate, manganese oxyhydroxide, or manganese sulfate; and a cobalt compound, such as cobalt oxide, cobalt carbonate, cobalt hydroxide, or cobalt sulfate. These starting materials are mixed in a predetermined ratio, provided that the lithium compound is used in excess. The mixture is fired in the atmosphere or an oxygen atmosphere at 800° C. to 1100° C. to give a solid solution as desired.

The positive electrode active material used in the secondary battery of the invention may consist solely of the lithium-transition metal complex oxide (1) or may further contain other active materials. Examples of other active materials useful in the positive electrode include lithium-transition metal complex oxides other than those of formula (I), such as LiCoO₂, LiNiO₂, LiMn₂O₄, and LiCO_{1/3}Ni_{1/3}Mn_{1/3}O₂. The amount of the other active materials may be about 1 to 5000% by weight based on the weight of the lithium-transition metal complex oxide (1).

The positive electrode that can be used in the secondary battery of the invention is obtained as follows. The lithium-transition metal complex oxide (1) is suspended in an appropriate solvent together with an electroconductive material, such acetylene black, and a binder, such as polyvinylidene fluoride, to make an active material mixture. The mixture is applied to at least one side of a current collector, such as aluminum foil, dried, rolled, and pressed.

The negative electrode that can be used in the secondary battery of the invention is composed of, for example, a current collector having on at least one side thereof a negative electrode active material layer. The negative electrode active material layer contains an active material. The active material that can be used in the invention is a substance containing Si or Sn.

The negative electrode active material containing Si is able to absorb and release lithium ions. Examples of the Si-containing active material include elemental silicon, alloys of silicon with a metal element(s), silicon oxides, silicon nitrides, and silicon borides. These materials may be used either individually or as a mixture thereof. The metal alloying with silicon is one or more elements selected from, for example, Cu, Ni, Co, Cr, Fe, Ti, Pt, W, Mo, and Au. Preferred of these elements are Cu, Ni, and Co. Cu and Ni are more preferred in terms of their high electron conductivity and low capability of forming a lithium compound. The Si-containing negative electrode active material may have lithium absorbed either before or after assembling the negative electrode into a battery. A particularly preferred Si-containing negative electrode active material is elemental silicon or silicon oxide for its high lithium absorption capacity.

Examples of the Sn-containing active material include elemental tin and alloys of tin with a metal element(s). These materials may be used either individually or as a mixture thereof. The metal alloying with tin is one or more elements selected from, for example, Cu, Ni, Co, Cr, Fe, Ti, Pt, W, Mo, and Au. Preferred of these elements are Cu, Ni, and Co. The tin alloy is exemplified by an Sn—Co—C alloy.

The negative electrode active material layer may be, for example, a continuous thin layer of the active material, which is formed on at least one side of a current collector by various thin film formation techniques including chemical vapor deposition, physical vapor deposition, and sputtering. The thin layer may be etched to form a number of voids extending in its thickness direction. Etching is carried out by wet processing using, e.g., a sodium hydroxide aqueous solution or dry processing using, e.g., dry gas or plasma. The negative electrode active material layer may be a particulate coating layer containing the active material in the form of particles or a sintered layer containing the active material in the form of particles. The negative electrode active material layer may also be a layer having the structure illustrated in FIG. 3.

The negative electrode active material layer may be a layer containing particles of the Si- or Sn-containing active material and particles of an electroconductive carbon or metallic material in a mixed state. For instance, particulate elemental silicon or silicon oxide is used as mixed with particulate electroconductive carbon or metallic material.

Exemplary and preferred separators to be used in the battery are nonwoven fabric of synthetic resins and porous film of polyolefins, such as polyethylene and polypropylene, or polytetrafluoroethylene. In order to suppress heat generation of the electrode due to overcharge of the battery, it is preferred to use, as a separator, a polyolefin microporous film having a ferrocene derivative thin film on one or both sides thereof. It is preferred for the separator to have a puncture strength of 0.2 to 0.49 N/μm-thickness and a tensile strength of 40 to 150 MPa in the winding axial direction so that it may suppress damage and thereby prevent occurrence of a short circuit even in using a Si- or Sn-based negative electrode active material that undergoes large expansion and contraction with charge/discharge cycles.

The nonaqueous electrolyte is a solution of a lithium salt, a supporting electrolyte, in an organic solvent. Examples of the lithium salt include CF₃SO₃Li, (CF₃SO₂)NLi, (C₂F₅SO₂)₂NLi, LiClO₄, LiAlCl₄, LiPF₆, LiAsF₆, LiSbF₆, LiCl, LiBr, LiI, and LiC₄F₉SO₃. These lithium salts may be used individually or as a combination of two or more thereof. Among them preferred are CF₃SO₃Li, (CF₃SO₂)NLi, and (C₂F₅SO₂)₂NLi for their superior resistance to decomposition by water. Examples of suitable organic solvents include ethylene carbonate, diethyl carbonate, dimethyl carbonate, propylene carbonate, and butylene carbonate. A nonaqueous electrolyte containing 0.5% to 5% by weight of vinylene carbonate, 0.1% to 1% by weight of divinyl sulfone, and 0.1% to 1.5% by weight of 1,4-butanediol dimethane sulfonate based on the total weight of the nonaqueous electrolyte is particularly preferred as bringing about further improvement on charge/discharge cycle characteristics. While not necessarily elucidated, the reason of the improvement the inventors believe is that 1,4-butanediol dimethane sulfonate and divinyl sulfone decompose stepwise to form a coating film on the positive electrode, whereby the coating film containing sulfur becomes denser.

For use in the nonaqueous electrolyte, highly dielectric solvents having a dielectric constant of 30 or higher, like halogen-containing, cyclic carbonic ester derivatives, such as 4-fluoro-1,3-dioxolan-2-one, 4-chloro-1,3-dioxolan-2-one, and 4-trifluoromethyl-1,3-dioxolan-2-one, are also preferred because they are resistant to reduction and therefore less liable to decompose. An electrolyte containing a mixture of the highly dielectric solvent and a low viscosity solvent with a viscosity of 1 mPa·s or less, such as dimethyl carbonate, diethyl carbonate, or methyl ethyl carbonate, is also preferred for obtaining higher ionic conductivity. It is also preferred for the electrolyte to contain 14 to 1290 ppm, by mass, of fluoride ion. It is considered that an adequate amount of fluoride ion present in the electrolyte forms a coating film of, for example, lithium fluoride generated from the fluoride ion on the negative electrode, which will suppress decomposition of the electrolyte on the negative electrode. It is also preferred for the electrolyte to contain 0.001% to 10% by weight of at least one additive selected from the group consisting of an acid anhydride and a derivative thereof. Such an additive is expected to form a coating film on the negative electrode, which will suppress decomposition of the electrolyte. Exemplary and preferred of such additives are cyclic compounds having a —C(═O)—O—C(˜O)— group in the ring thereof, including succinic anhydride, glutaric anhydride, maleic anhydride, phthalic anhydride, 2-sulfobenzoic anhydride, citraconic anhydride, itaconic anhydride, diglycolic anhydride, hexafluoroglutaric anhydride; phthalic anhydride derivatives, such as 3-fluorophthalic anhydride and 4-fluorophthalic anhydride; 3,6-epoxy-1,2,3,6-tetrahydrophthalic anhydride, 1,8-naphthalic anhydride, 2,3-anphthalenecarboxylic anhydride; 1,2-cycloalkanedicarboxylic acids, such as 1,2-cyclopentanedicarboxylic anhydride and 1,2-cyclohexanedicarboxylic anhydride; tetrahydrophthalic anhydrides, such as cis-1,2,3,6-tetrahydrophthalic anhydride and 3,4,5,6-tetrahydrophthalic anhydride; hexahydrophthalic anhydrides (cis-form and trans-form), 3,4,5,6-tetrachlorophthalic anhydride, 1,2,4-benzenetricarboxylic anhydride, and pyromellitic dianhydride; and derivatives of these acid anhydrides.

FIG. 3 is a schematic cross-sectional view of a preferred embodiment of the negative electrode that can be used in the invention. The negative electrode 10 of the present embodiment has a current collector 11 and an active material layer 12 on at least one side of the current collector 11. Although FIG. 3 shows only one active material layer 12 for the sake of convenience, the active material layer may be provided on both sides of the current collector 11.

In the active material layer 12, particles 12a of the Si-containing active material are coated at least partially with a coat of a metallic material 13 having low capability of forming a lithium compound. The metallic material 13 is different from the material making up the particles 12a. There are voids between the metallic material-coated particles 12a. That is, the metallic material covers the surface of the particles 12a while leaving interstices through which a nonaqueous electrolyte containing lithium ions may reach the particles 12a. In FIG. 3, the metallic material 13 is depicted as a thick solid line defining the perimeter of the individual particles 12a for the sake of clarify of the drawing. The individual particles are in contact with one another either directly or via the metallic material 13. As used herein, the expression “low capability of forming a lithium compound” means no capability of forming an intermetallic compound or a solid solution with lithium or, if any, the capability is so limited that the resulting lithium compound contains only a trace amount of lithium or is unstable.

The metallic material 13 has electroconductivity and is exemplified by copper, nickel, iron, cobalt, and their alloys. A highly ductile metallic material is preferred, which forms a stable electroconductive metallic network throughout the whole active material layer against expansion and contraction of the active material particle 12a. A preferred example of such a material is copper.

It is preferred that the metallic material 13 on the surface of the active material particles 12a is present over the entire thickness of the active material layer 12 in a manner that the particles 12a exist in the matrix of the metallic material 13. By such a configuration, the particles 12a hardly fall off even when they pulverize due to expansion and contraction accompanying charge/discharge cycles. Furthermore, electron conductivity across the active material layer 12 is secured by the metallic material 13 so that occurrence of an electrically isolated particle 12a, especially in the depth of the active material layer 12, is prevented effectively. Whether the metallic material 13 is present on the surface of the active material particles 12a over the entire thickness of the active material layer 12 can be confirmed by mapping the metallic material 13 using an electron microscope.

The metallic material 13 covers the surface of the individual particles 12a continuously or discontinuously. Where the metallic material 13 covers the surface of the individual particles 12 continuously, it is preferred that the coat of the metallic material 13 has micropores for the passage of a nonaqueous electrolyte. Where the metallic material 13 covers the surface of the individual particles 12a discontinuously, a nonaqueous electrolyte is supplied to the particles 12a through the non-coated part of the surface of the particles 12a. Such a coat of the metallic material 13 is formed by, for example, depositing the metallic material 13 on the surface of the particles 12a by electroplating under the conditions described infra.

The average thickness of the metallic material 13 covering the surface of the active material particles 12a is preferably as thin as 0.05 to 2 μm, more preferably 0.1 to 0.25 μm. The metallic material 13 thus covers the active material particles 12a with this minimum thickness, thereby to prevent falling-off of the particles 12a having pulverized as a result of expansion and contraction accompanying charge/discharge cycles while improving the energy density. As used herein the term “average thickness” denotes an average calculated from the thicknesses of the metallic material 13 coat actually covering the surface of the particle 12a. The non-coated part of the surface of the particle 12a is excluded from the basis of calculation.

The voids formed between the particles 12a coated with the metallic material 13 serve as a flow passage for a nonaqueous electrolyte containing lithium ions. The voids allow the nonaqueous electrolyte to circulate smoothly in the thickness direction of the active material layer 12, thereby achieving improved cycle characteristics. The voids formed between the particles 12a also afford vacant spaces to serve to relax the stress resulting from volumetric changes of the active material particles 12a accompanying charge and discharge cycles. The volume gain of the active material particles 12a resulting from charging is absorbed by the voids. Thus, the particles 12a are less liable to pulverize, and noticeable deformation of the negative electrode 10 is avoided effectively.

The active material layer 12 is preferably formed by applying a slurry containing the particles 12a and a binder to a current collector, drying the applied slurry to form a coating layer, and electroplating the coating layer in a plating bath having a prescribed composition to deposit a metallic material 13 between the particles 12a, as will be described infra.

In order to form necessary and sufficient voids through which a nonaqueous electrolyte is allowed to pass in the active material layer 12, it is preferred that a plating bath thoroughly penetrates the coating layer. In addition to this, it is preferred that the conditions for depositing the metallic material 13 by electroplating using the plating bath are properly selected. Such conditions include the composition and pH of the plating bath and the electrolytic current density. The pH of the plating bath is preferably 7.1 to 11. With a plating bath having a pH in that range, the surface of the active material particles 12a is cleaned (while dissolution of the particles 12a is suppressed), which accelerates deposition of the metallic material 13 thereon, while leaving moderate voids between the particles 12a. The pH value as referred to herein is as measured at the plating temperature.

In plating with copper as a metallic material 13, a copper pyrophosphate plating bath is preferably used. In using nickel as a metallic material, an alkaline nickel bath, for example, is preferably used. To use a copper pyrophosphate plating bath is advantageous in that the aforementioned voids can easily be formed over the entire thickness of the active material layer 12 even when the active material layer has an increased thickness. Using a copper pyrophosphate bath offers an additional advantage that the metallic material 13, while being deposited on the surface of the active material particles 12a, is hardly deposited between the particles 12a so as to successfully leave vacant spaces therebetween. In using a copper pyrophosphate bath, a preferred composition and pH of the bath and preferred electrolysis conditions are as follows.

Copper pyrophosphate trihydrate: 85-120 g/l

Potassium pyrophosphate: 300-600 g/l

Potassium nitrate: 15-65 g/l

Bath temperature: 45-60° C.

Current density: 1-7 A/dm²

pH: adjusted to 7.1 to 9.5, by the addition of aqueous ammonia and polyphosphoric acid.

When in using a copper pyrophosphate bath, the bath preferably has a weight ratio of P₂O₇ to Cu, P₂O₇/Cu (hereinafter referred to as a P ratio), of 5 to 12. With a bath having a P ratio less than 5, the metallic material 13 covering the active material particles 12a tends to be thick, which can make it difficult to secure voids as expected between the active material particles 12a. With a bath having a P ratio more than 12, the current efficiency is deteriorated, and gas generation tends to accompany, which can result in reduced stability of production. A still preferred P ratio of a copper pyrophosphate plating bath is 6.5 to 10.5. When a plating bath with a still preferred P ratio of 6.5 to 10.5 is used, the size and the number of the voids formed between the active material particles 12a are very well suited for the passage of a nonaqueous electrolyte in the active material layer 12.

When in using an alkaline nickel bath, a preferred composition and pH of the bath and preferred electrolysis conditions are as follows.

Nickel sulfate: 100-250 g/l

Ammonium chloride: 15-30 g/l

Boric acid: 15-45 g/l

Bath temperature: 45-60° C.

Current density: 1-7 A/dm²

pH: adjusted to 8-11 by the addition of 100-300 g/l of 25 wt % aqueous ammonia.

Plating using the copper pyrophosphate bath is preferred to plating using the alkaline nickel plating bath; for the former tends to form adequate vacant spaces in the active material layer 12 thereby providing a negative electrode with a prolonged life as compared with the latter plating.

Various additives used in an electrolytic solution for the production of copper foil, such as proteins, active sulfur compounds, and cellulose compounds, may be added to the plating bath to appropriately control the characteristics of the metallic material 13.

It is preferred that the active material layer formed by the above described various methods has a void fraction (the proportion of the void volume in the total volume of the layer) of about 15% to 45%, more preferably about 20 to 40%, by volume. With the void fraction falling in that range, voids necessary and sufficient for a nonaqueous electrolyte to circulate are formed in the active material layer 12. The void fraction of the active material layer 12 is determined by mercury intrusion porosimetry or, simply, mercury porosimetry (JIS R1655). Mercury porosimetry is a technique for obtaining information about the physical form of a solid substance through measurement of the pore size and volume. Mercury porosimetry consists of pressing mercury to make the mercury intrude into pores of a sample, and measuring the reference of the pressure to the volume of mercury which penetrates a sample under increasing pressure. Mercury intrudes into pores of the active material layer 12 in the order of decreasing pore size. In the present invention, the void volume measured under a pressure of 90 MPa is taken as the total void volume. The void fraction (%) of the active material layer 12 is obtained by dividing the void volume per unit area measured as above by the apparent volume of the active material layer 12 per unit area and multiplying the quotient by 100.

It is preferred in the present embodiment that the active material layer 12 of the negative electrode 10 has a void fraction of 10% to 40% as calculated from the void volume measured by mercury porosimetry under a pressure of 10 MPa as well as the above specified void fraction measured by mercury porosimetry. It is also preferred that the active material layer 12 has a void fraction of 0.5% to 15% as calculated from the void volume measured by mercury porosimetry under a pressure of 1 MPa. It is also preferred that the active material layer 12 has a void fraction of 1% to 35% as calculated from the void volume measured by mercury porosimetry under a pressure of 5 MPa. As previously stated, mercury porosimetry uses an increasing pressure for mercury intrusion. Mercury intrudes into large pores under low pressures and small pores under high pressures. Accordingly, the void fraction measured at 1 MPa is assigned primarily to large voids, while the void fraction measured at 10 MPa reflects the presence of smaller voids.

It is considered that the large voids as referred to above are vacant spaces mainly formed between the active material particles 12a and that the small voids as referred to above are vacant spaces mainly between the crystal grains of the metallic material 13 on the surface of the active material particles 12a. The large voids function chiefly as spaces for relaxing the stress due to the expansion and contraction of the active material particles 12a. On the other hand, the small voids serve chiefly as flow passage for supply of a nonaqueous electrolyte to the active material particles 12a. Achieving a good balance between the amount of the large voids and the amount of the small voids brings about further improved cycle characteristics.

The void fraction may also be controlled by properly selecting the particle size of the active material particles 12a. From this viewpoint, the particles 12a preferably have the maximum particle size of 30 μm or smaller, more preferably 10 μm or smaller, and an average particle size of 0.1 to 8 μm, more preferably 0.3 to 4 μm, in terms of D₅₀. The particle size D₅₀ is determined by particle size distribution measurement with a laser diffraction scattering particle size analyzer or by observation under a scanning electron microscope (SEM).

When the amount of the active material based on the whole negative electrode is too small, it is difficult to sufficiently increase the energy density. When the amount is too large, the active material layer has reduced strength, and the active material is apt to come off. A suitable thickness of the active material layer 12 for these considerations is preferably 10 to 40 μm, more preferably 15 to 30 μm, even more preferably 18 to 25 μm.

The negative electrode 10 of the present embodiment may or may not have a thin surface layer (not shown in the drawing) on the active material layer 12. The thickness of the surface layer is as thin as 0.25 μm or less, preferably 0.1 μm or less. There is not lower limit to the thickness of the surface layer. To form such a surface layer provides further protection against falling-off of the active material particles 12a having pulverized. Note that, nevertheless, falling-off of the active material particles 12a having pulverized is sufficiently prevented even in the absence of the surface layer by controlling the void fraction of the active material layer within the above-recited range.

In the absence of a surface layer or in the presence of a very thin surface layer on the negative electrode 10, the overpotential in initial charge of a secondary battery assembled by using the negative electrode 10 can be reduced. This means that reduction of lithium on the surface of the negative electrode 10 during charging the secondary battery is avoided. Reduction of lithium can lead to the formation of lithium dendrite that can cause a short circuit between the electrodes.

In the cases where the negative electrode 10 has a surface layer, the surface layer covers the surface of the active material layer 12 continuously or discontinuously. Where the surface layer continuously covers the active material layer 12, the surface layer preferably has a number of micropores (not shown in the drawing) open on its surface and connecting to the active material layer 12. The micropores preferably extend in the thickness direction of the surface layer. The micropores enable passage of a nonaqueous electrolyte. The role of the micropores is to supply a nonaqueous electrolyte into the active material layer 12. The amount of the micropores is preferably such that when the surface of the negative electrode 10 is observed from above under an electron microscope, the ratio of the area covered with the metallic material 13, namely a coating ratio, is not more than 95%, more preferably 80% or less, even more preferably 60% or less. If the coating ratio exceeds 95%, a viscous nonaqueous electrolyte would encounter difficulty in penetrating, which may narrow the range for choice of a nonaqueous electrolyte.

The surface layer is formed of a metallic material having low capability of forming a lithium compound. The metallic material forming the surface layer may be the same or different from the metallic material 13 present in the active material layer 12. The surface layer may be composed of two or more sublayers of different metallic materials. Taking into consideration ease of production of the negative electrode 10, the metallic material 13 present in the active material layer 12 and the metallic material forming the surface layer are preferably the same.

The negative electrode 10 of the present embodiment has high endurance to folding owing to the high porosity (void fraction) of the active material layer 12. More specifically, the negative electrode 10 preferably has an MIT folding endurance of 30 or more, more preferably 50 or more, as tested in accordance with JIS C6471. To have high folding endurance is very advantageous in that the negative electrode 10 hardly breaks when folded or rolled to be placed into a battery case. MIT folding endurance is measured using, for example, an MIT folding endurance tester available from Toyo Seiki Seisakusho, Ltd. (Model 549) under conditions of a bending radius of 0.8 mm, a load of 0.5 kgf, and a sample size of 15×150 mm.

Any current collector conventionally used in negative electrodes for nonaqueous secondary batteries can be used as the current collector 11 of the negative electrode 10. The current collector 11 is preferably made out of the above-described metallic material having low capability of forming a lithium compound, examples of which are given previously. Preferred of them are copper, nickel, and stainless steel. Copper alloy foil typified by Corson alloy foil is also usable. Metal foil preferably having a dry tensile strength (JIS C2318) of 500 MPa or more, for example, Corson alloy foil having a copper coat on at least one side thereof is also useful as a current collector. A current collector having dry elongation (JIS C2318) of 4% or more is preferably used. A current collector with low tensile strength is liable to wrinkle due to the stress of the expansion of the active material. A current collector with low elongation tends to crack due to the stress. Using a current collector made of these preferred materials ensures the folding endurance of the negative electrode 10. The thickness of the current collector 11 is preferably 9 to 35 μm in view of the balance between retention of strength of the negative electrode 10 and improvement of energy density. In the case of using copper foil as a current collector 11, it is recommended to subject the copper foil to anti-corrosion treatment, like chromate treatment or treatment with an organic compound such as a triazole compound or an imidazole compound.

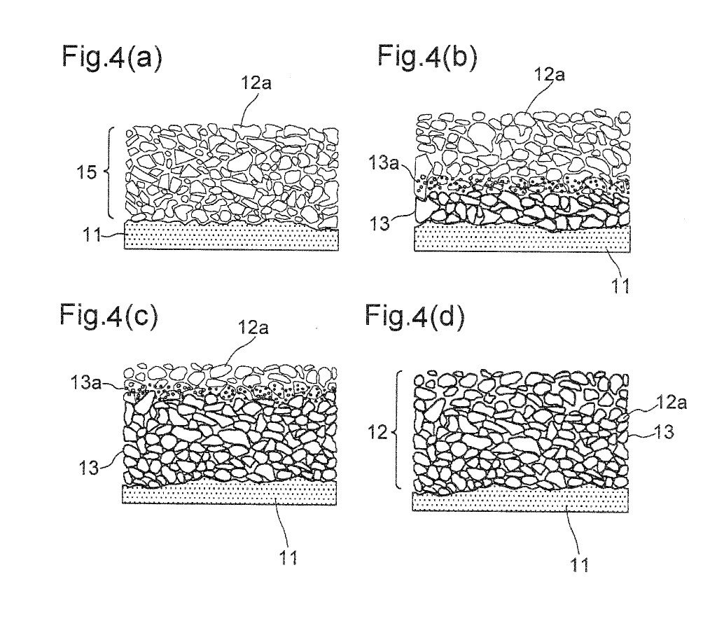

A preferred process of producing the negative electrode 10 of the present embodiment will then be described with reference to FIG. 4. The process includes the steps of forming a coating layer on a current collector 11 using a slurry containing active material particles and a binder and subjecting the coating layer to electroplating.

As illustrated in FIG. 4(a), a current collector 11 is prepared, and a slurry containing active material particles 12a is applied thereon to form a coating layer 15. The surface of the current collector 11 on which the slurry is to be applied preferably has a surface roughness of 0.5 to 4 μm in terms of maximum peak height of the surface profile. If the maximum peak height exceeds 4 μm, not only is the precision of coating layer formation reduced but also an electric current of penetration plating can concentrate at the peaks. When the maximum peak height is less than 0.5 μm, the active material layer 12 tends to have reduced adhesion to the current collector 11. The active material particles 12a preferably have the aforementioned particle size distribution and average particle size.

The slurry contains a binder, a diluting solvent, etc. in addition to the active material particles. The slurry may further contain a small amount of particles of an electroconductive carbon material, such as acetylene black or graphite. Where, in particular, the active material particles 12a are of a silicon-based material, it is preferred to add the electroconductive carbon material in an amount of 1% to 3% by weight based on the active material particles 12a. With less than 1% by weight of an electroconductive carbon material, the slurry has a reduced viscosity so that the active material particles 12a cause sedimentation easily in the slurry, which can result in a failure to form a desired coating layer 15 with uniform voids. If the electroconductive carbon material content exceeds 3% by weight, plating nuclei tend to concentrate on the surface of the electroconductive carbon material, which can also result in a failure to form a desired coating layer.

Examples of the binder include styrene-butadiene rubber (SBR), polyvinylidene fluoride (PVDF), polyethylene (PE), and ethylene-propylene-diene terpolymer (EPDM). Examples of the diluting solvent include N-methylpyrrolidone and cyclohexane. The slurry preferably contains about 30% to 70% by weight of the active material particles 12a and about 0.4% to 4% by weight of the binder. A diluting solvent is added to these materials to prepare the slurry.

The coating layer 15 thus formed has a number of fine vacant spaces between the particles 12a. The current collector 11 with the coating layer 15 is then immersed in a plating bath containing a metallic material having low capability of forming a lithium compound. Whereupon, the plating bath infiltrates into the vacant spaces and reaches the interface between the coating layer 15 and the current collector 11. In this state, electroplating is conducted to deposit the plating metal species on the surface of the particles 12a (we call electroplating of this type “penetration plating”). Penetration plating is performed by immersing the current collector 11 as a cathode and a counter electrode (anode) in the plating bath and connecting the two electrodes to a power source.

It is preferred to have the metallic material deposited in a direction from one side to the opposite side of the coating layer 15. Specifically, electroplating is carried out in a manner such that deposition of the metallic material 13 proceeds from the interface between the coating layer 15 and the current collector 11 toward the surface of the coating layer 15 as illustrated in FIGS. 4(b) through 4(d). By causing the metallic material 13 to be deposited in that way, the active material particles 12a are successfully coated with the metallic material 13, and voids are successfully formed between the metallic material-coated particles 12a coated with the metallic material 13.

The conditions of penetration plating for depositing the metallic material 13 as described above include the composition and pH of the plating bath and the electrolytic current density, which have been described supra.

As shown in FIGS. 4(b) to 4(d), when electroplating is carried out in a manner such that deposition of the metallic material 13 proceeds from the interface between the coating layer 15 and the current collector 11 to the surface of the coating layer, there always are microfine particles 13a comprising plating nuclei of the metallic material 13 in a layer form with an almost constant thickness along the front of the deposition reaction. With the progress of the deposition of the metallic material 13, neighboring microfine particles 13a gather into larger particles, which, with further progress of the deposition, gather one another to continuously coat the surface of the active material particles 12a.

The electroplating is stopped at the time when the metallic material 13 is deposited over the entire thickness of the coating layer 15. If desired, a surface layer (not shown) may be formed on the active material layer 12 by adjusting the end point of the plating. There is thus obtained a desired negative electrode as illustrated in FIG. 4(d). In the case of making a surface layer of a metal different from the metallic material 13, the penetration plating is once stopped when the metallic material 13 is deposited over the entire thickness of the coating layer 15, and plating is continued in a different plating bath to form a surface layer on the coating layer 15.

After the penetration plating, the resulting negative electrode 10 may preferably be subjected to anti-corrosion treatment. Anti-corrosion treatment can be carried out using organic compounds, such as triazole compounds (e.g., benzotriazole, carboxybenzotriazole, and tolyltriazole) and imidazole, or inorganic substances, such as cobalt, nickel, and chromates.

While the present invention has been described based on its preferred embodiments, the invention is not limited to the embodiments. For example, in the foregoing embodiments, the secondary battery is constructed by using the lithium-transition metal complex oxide (1) as a positive electrode active material and a Si- or Sn-containing active material as a negative electrode active material, and the amounts of these active materials are decided so that the theoretical capacity of the negative electrode may be 1.1 to 3.0 times the capacity of the positive electrode at a cut-off voltage for the first and subsequent charging operations. The invention further includes an embodiment in which the amounts of the positive and the negative electrode active materials, irrespective of their kinds, are decided so that the theoretical capacity of the negative electrode may be 1.1 to 3.0 times the capacity of the positive electrode at a charge cut-off voltage, and charge and discharge cycles are controlled so that the negative electrode capacity at the charge cut-off voltage ranges from 0% to 90% of the theoretical capacity of the negative electrode. In this embodiment, it is preferable that lithium corresponding to 50% to 90% of the theoretical capacity of the negative electrode is supplied to the negative electrode prior to the charge and discharge cycle. Providing an irreversible capacity to the negative electrode prior to the charge/discharge cycle can be accomplished by, for example, the above described preliminary charge, by which lithium is supplied from the positive to the negative electrode and absorbed in the negative electrode. Alternatively, lithium may be absorbed in the negative electrode by the method disclosed in JP 7-29602A or the method previously proposed in commonly assigned JP 2006-269216A. The amount of irreversible capacity is preferably such that the amount of the part of the lithium supplied to the negative electrode by these operations that is accumulated in the negative electrode without being returned to the positive electrode by discharge is 9% to 50%, more preferably 9% to 40%, even more preferably 10% to 30%, of the theoretical capacity of the negative electrode.

When a secondary battery is conditioned according to the above mentioned embodiment, it is especially preferred to use a lithium-transition metal complex oxide, such as LiCoO₂, LiNiO₂, LiMn₂O₄, or LiCO_{1/3}Ni_{1/3}Mn_{1/3}O₂, as a positive electrode active material, and it is especially preferred to use a material containing Si or Sn and capable of absorbing and releasing lithium as a negative electrode active material.

### EXAMPLES

The present invention will now be illustrated in greater detail with reference to Examples, but it should be understood that the invention is not construed as being limited thereto.

### Example 1

### (1) Preparation of Positive Electrode

A sodium hydroxide aqueous solution was added to a mixture of a manganese sulfate aqueous solution and a cobalt sulfate aqueous solution to prepare an Mn:Co=1:1 coprecipitated powder. The powder was washed well with ion exchanged water, dried, and chemically analyzed to determine Mn and Co. Lithium carbonate was thoroughly mixed with the powder to give an Li:(Mn+Co) of 1.2:0.8, and the mixed powder was fired at 900° C. for 24 hours to yield a lithium-transition metal complex oxide (1) in which x=0.2. The value x was determined by ICP analysis for Li, Mn, and Co. It was also confirmed by X-ray diffractometry that the lithium-transition metal complex oxide is a layer compound. The lithium-transition metal complex oxide was used as a positive electrode active material. The positive electrode active material was suspended in N-methylpyrrolidone (solvent) together with acetylene black (AB) and polyvinylidene fluoride (PVdF) to obtain a positive electrode active material mixture having a lithium-transition metal complex oxide:AB:PVdF of 88:6:6 by weight. The active material mixture was applied to a 20 μm thick aluminum foil (current collector) with an applicator, dried at 120° C., and roller pressed under a pressure of 0.5 ton/cm to make an about 70 μm thick positive electrode, from which a 13 mm diameter disk was stamped out.

### (2) Preparation of Negative Electrode

A 18 μm thick electrolytic copper foil as a current collector was cleaned with an acid at room temperature for 30 seconds and washed with pure water for 15 seconds. A slurry of Si particles was applied to the current collector to a thickness of 15 μm to form a coating layer. The slurry contained the particles, styrene-butadiene rubber (binder), and acetylene black at a weight ratio of 100:1.7:2. The particles had an average particle size D₅₀ of 2 μm as measured using a laser diffraction scattering particle size analyzer Microtrack (Model 9320-X100) available from Nikkiso Co., Ltd.

The current collector having the coating layer was immersed in a copper pyrophosphate plating bath having the following composition, and the coating layer was penetration-plated with copper by electrolysis under the following electrolysis conditions to form an active material layer. A DSE was used as an anode, and a direct current power source was used.

Copper pyrophosphate trihydrate: 105 g/l

Potassium pyrophosphate: 450 g/l

Potassium nitrate: 30 g/l

P ratio: 7.7

Bath temperature: 50° C.

Current density: 3 A/dm²

pH: adjusted to 8.2 by the addition of aqueous ammonia and polyphosphoric acid.

The penetration plating was stopped at the time when copper was deposited over the entire thickness of the coating layer. A cross-section of the resulting negative electrode was observed under an SEM to find that the active material particles in the active material layer were covered with a copper layer with an average thickness of 240 nm. The active material layer had a void fraction of 30%. A 14 mm diameter disk was stamped out of the resulting negative electrode. The theoretical capacity of the negative electrode was found to be 10.9 mAh as measured by the previously described method.

### (3) Fabrication of Lithium Secondary Battery

The negative and positive electrodes thus prepared were assembled into a size 2032 coin battery together with a 20 μm thick polypropylene porous film as a separator. A 1 mol/l LiPF₆ solution in a 1:1 by volume mixed solvent of ethylene carbonate and diethyl carbonate having 2% by volume vinylene carbonate externally adding thereto was used as an electrolyte. The negative/positive electrode capacity ratio (the ratio of the theoretical capacity of the negative electrode to the capacity of the positive electrode at the charge cut-off potential shown in Table 1 below) of the resulting battery was as shown in Table 1.

### Examples 2 and 3

Size 2032 coin batteries were fabricated in the same manner as in Example 1, except that the lithium-transition metal complex oxide (1) (x=0.2) was prepared by the process described below. The negative/positive electrode capacity ratio (the ratio of the theoretical capacity of the negative electrode to the capacity of the positive electrode at the charge cut-off potential shown in Table 1 below) of the resulting batteries is shown in Table 1.

Lithium carbonate, manganese dioxide, and cobalt hydroxide were weighed out in a molar ratio Li:Mn:Co of 1.2:0.4:0.4, mixed together, slurried in a wet pulverizer, and spray-dried. The resulting particles were fired at 900° C. for 24 hours to give the desired lithium-transition metal complex oxide.

### Examples 4 to 6

A size 2032 coin battery was fabricated in the same manner as in Example 1, except for using Li(Li_{0.03}Mn_{0.06} Co_{0.91})O₂ (Example 4), Li(Li_{0.07}Mn_{0.14} CO_{0.79})O₂ (Example 5), or Li(Li_{0.13}Mn_{0.26} CO_{0.61})O₂ (Example 6) which were prepared by the same spray dry process as used in Example 2. The negative/positive electrode capacity ratio (the ratio of the theoretical capacity of the negative electrode to the capacity of the positive electrode at the charge cut-off potential shown in Table 1 below) of the resulting batteries is shown in Table 1.

### Comparative Examples 1 and 2

Size 2032 coin batteries were fabricated in the same manner as in Example 1, except for replacing the positive electrode active material used in Example 1 with LiCoO₂. The negative/positive electrode capacity ratio (the ratio of the theoretical capacity of the negative electrode to the capacity of the positive electrode at the charge cut-off potential shown in Table 1 below) of the resulting batteries is shown in Table 1.

### Example 7

A size 2032 coin battery was fabricated in the same manner as in Example 4, except for changing the conditions for the preliminary charge and the first and subsequent charge/discharge cycles as shown in Table 1. The negative/positive electrode capacity ratio (the ratio of the theoretical capacity of the negative electrode to the capacity of the positive electrode at the charge cut-off potential shown in Table 1 below) of the resulting battery is shown in Table 1.

### Comparative Example 3

A size 2032 coin battery was fabricated in the same manner as in Example 7, except for replacing the positive electrode active material used in Example 7 with LiCoO₂. The negative/positive electrode capacity ratio (the ratio of the theoretical capacity of the negative electrode to the capacity of the positive electrode at the charge cut-off potential shown in Table 1 below) of the resulting battery is shown in Table 1.

### Evaluation

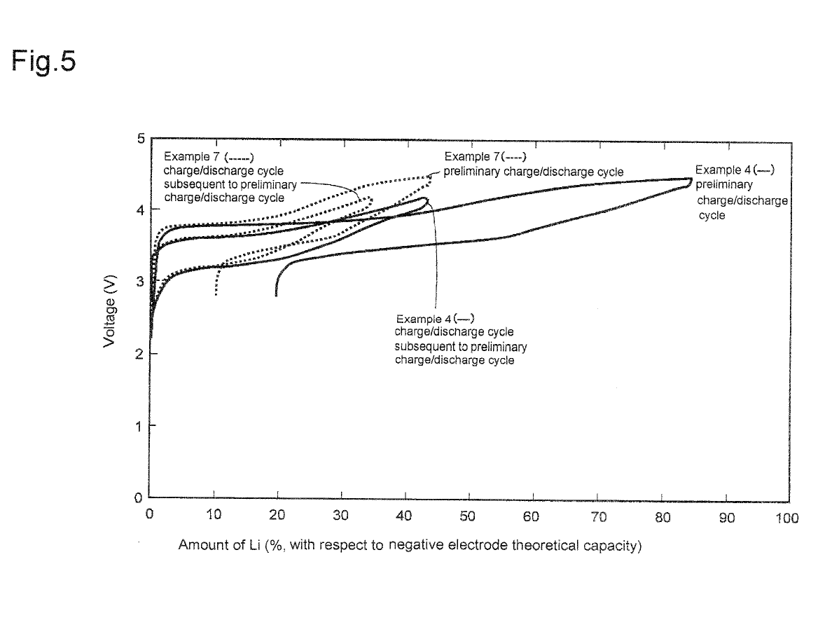

Each of the batteries obtained in Examples and Comparative Examples was preliminary charged at a charging rate of 0.05 C to a cut-off potential shown in Table 1 in a constant current/constant voltage method (the cut-off current was ⅕ the constant current). The amount of lithium supplied to the negative electrode by the preliminary charge based on the negative electrode theoretical capacity is shown in Table 1. The battery was then discharged in a constant current mode at a discharge rate of 0.05 C at a cut-off voltage of 2.8 V. The irreversible capacity after the discharge (i.e., the amount of lithium accumulated in the negative electrode after the discharge) relative to the negative electrode theoretical capacity is shown in Table 1. Subsequently, the battery was charged and discharged 200 cycles (in which the preliminary charge was not counted), in which the charge was performed in a constant current/constant voltage mode (the cut-off current was ⅕ the constant current) at a charging rate of 0.5 C to the cut-off voltage shown in Table 1, and the discharge was conducted in a constant current mode at a discharging rate of 0.5 C to a cut-off voltage of 2.8 V. The range of the charge and discharge with respect to the negative electrode capacity at the charge cut-off voltage shown in Table 1 was as shown in Table 1. The first discharge capacity which is performed after the preliminary charge/discharge was measured. The results are shown in Table 1. The discharge capacity in the 200th cycle was measured. The capacity retention at the 200th cycle was calculated from the first discharge capacity and the 200th cycle discharge capacity. The results obtained are shown in Table 1. The charge/discharge curves in the preliminary charge and the subsequent discharge of the batteries obtained in Examples 4 and 7 are shown in FIG. 5.

TABLE 1

| | | | Preliminary Charge | | | |
|---|---|---|---|---|---|---|
| | | | | | Discharge | Irreversible Capacity |
| | | | | Li Supply (%) | Capacity after | with respect to |
| | | | | with respect to | Preliminary | Negative Electrode |
| | | | Cut-off | Negative Electrode | Charge | Theoretical Capacity |
| | Positive Electrode | Negative Electrode | Potential (V)* | Theoretical Capacity | (mAh) | (%) |
| Example 1 | Li(Li_{0.2}Mn_{0.4}Co_{0.4})O₂ | Si | 4.6 | 87 | 5.4 | 30 |
| | (coprecipitated) | | | | | |
| Example 2 | Li(Li_{0.2}Mn_{0.4}Co_{0.4})O₂ | | 4.6 | 86 | 5.3 | 30 |
| | (spray dried) | | | | | |
| Example 3 | Li(Li_{0.2}Mn_{0.4}Co_{0.4})O₂ | | 4.4 | 42 | 3.1 | 9 |
| | (spray dried) | | | | | |
| Example 4 | Li(Li_{0.03}Mn_{0.06}Co_{0.91})O₂ | | 4.6 | 84 | 5.8 | 20 |
| | (spray dried) | | | | | |
| Example 5 | Li(Li_{0.07}Mn_{0.14}Co_{0.79})O₂ | | 4.6 | 82 | 5.7 | 21 |
| | (spray dried) | | | | | |
| Example 6 | Li(Li_{0.13}Mn_{0.26}Co_{0.61})O₂ | | 4.6 | 85 | 5.9 | 22 |
| | (spray dried) | | | | | |
| Comp. | LiCoO₂ | | 4.4 | 57 | 4.5 | 9 |
| Example 1 | | | | | | |
| Comp. | LiCoO₂ | | 4.6 | 72 | 5.6 | 12 |
| Example 2 | | | | | | |
| Example 7 | Li(Li_{0.03}Mn_{0.06}Co_{0.91})O₂ | | 4.3 | 43 | 3.1 | 10 |
| | (spray dried) | | | | | |
| Comp. | LiCoO₂ | | 4.3 | 55 | 4.4 | 8 |
| Example 3 | | | | | | |

| | | | Charge/Discharge | |
|---|---|---|---|---|
| | | | Range with respect | 200th Cycle |
| | Negative/Positive | Charge | to Negative Electrode | Capacity |
| | Electrode Capacity | Cut-off Voltage | Capacity | Retention |
| | Ratio | (V) | (%) | (%) |
| Example 1 | 2.6 | 4.2 | 22-60 | 82 |
| Example 2 | 2.6 | 4.2 | 22-61 | 81 |
| Example 3 | 3.0 | 4.2 | 0-35 | 79 |
| Example 4 | 2.3 | 4.2 | 12-56 | 90 |
| Example 5 | 2.4 | 4.2 | 12-53 | 86 |
| Example 6 | 2.5 | 4.2 | 13-54 | 83 |
| Comp. | 2.2 | 4.2 | 0-45 | 35 |
| Example 1 | | | | |
| Comp. | 2.4 | 4.2 | 5-46 | 11 |
| Example 2 | | | | |
| Example 7 | 3.1 | 4.2 | 1-34 | 64 |
| Comp. | 2.2 | 4.2 | 1-46 | 42 |
| Example 3 | | | | |

*vs. Li/Li⁺

As is apparent from the results in Table 1, the batteries of the invention have an increased first discharge capacity by conducting the preliminary charge at an elevated cut-off potential and have prolonged cycle life (Examples 1 and 2). When the preliminary charge cut-off potential is decreased (Example 3), although the discharge capacity reduces as compared with the case of elevating the cut-off potential, the cycle characteristics are improved as compared with Comparative Examples.

In contrast, it is seen that, when the preliminary charge cut-off potential is increased, the battery of Comparative Example 2 shows extremely deteriorated cycle characteristics. This is ascribable to destruction of the crystal structure of the positive electrode active material LiCoO₂ due to overcharge. When, on the other hand, the preliminary charge cut-off potential is lowered (Comparative Example 1), the cycle characteristics of the battery does not reduce so abruptly but are still poorer than those of the battery of Example with the preliminary charge cut-off potential condition being equal.

As is apparent from the comparison between Example 7 and Comparative Example 3, even when the preliminary charge is performed at a cut-off potential used for conventional batteries, i.e., 4.3 V, the battery of Example 7 using the lithium-transition metal complex oxide (1) as a positive electrode active material proves to have a higher capacity retention than the battery of Comparative Example 3 using LiCoO₂, a conventional positive electrode active material.

Furthermore, comparison between Examples 4 and 7 and the charge/discharge curves in FIG. 5 reveal the following. The battery of Example 4 having been preliminarily charged at an elevated cut-off potential (4.6 V) exhibits a reduction in reversibility in the discharge subsequent to the preliminary charge, indicating that lithium largely remains in the negative electrode as irreversible capacity. On the other hand, the battery of Example 7 having been preliminarily charged at a lower cut-off potential (43 V) exhibits better reversibility in the discharge subsequent to the preliminary charge, indicating that a less amount of lithium remains in the negative electrode as irreversible capacity. Thus, by elevating the cut-off potential in the preliminary charge from 4.3 V to 4.6 V, the reversibility greatly changes, and the amount of lithium that remains in the negative electrode as irreversible capacity increases.

### Example 8 and Comparative Example 4

Batteries were made in the same manner as in Example 1 using the same negative electrode as used in Example 1 and using metallic lithium as a counter electrode. Each of the batteries was charged to supply lithium of an amount corresponding to 90% of the negative electrode theoretical capacity to the negative electrode. Then, the battery was disassembled to take out the negative electrode. Separately, a positive electrode was prepared in the same manner as in Example 1, except for using LiCO_{1/3}Ni_{1/3}Mn_{1/3}O₂ as an active material. A battery was fabricated using the resulting positive electrode and the above-prepared negative electrode together with the same electrolyte and separator as used in Example 1. The resulting battery was subjected to charge/discharge cycles under the conditions shown in Table 2 below. The charge/discharge conditions other than those shown in Table 2 were the same as in Example 1. The capacity retentions at the 100th and 200th cycles were determined in the same manner as in Example 1. The results obtained are shown in Table 2.

TABLE 2

| | Preliminary Charge | | | |
|---|---|---|---|---|
| | Li Supply with | Irreversible Capacity | | |
| | respect to Negative | with respect to | | Charge |
| | Electrode Theoretical | Negative Electrode | Negative/Positive Electrode | Cut-off |
| | Capacity (%) | Theoretical Capacity (%) | Capacity Ratio | Voltage (V) |
| Example 8 | 90 | 20 | 3.3 | 4.2 |
| | | | 2.5 | |
| | | | 2.2 | |
| | | | 2.0 | |
| | | | 1.8 | |
| | | | 1.7 | |
| | | | 1.5 | |
| | | | 1.4 | |
| | | 30 | 3.3 | 4.2 |
| | | | 2.5 | |
| | | | 2.2 | |
| | | | 2.0 | |
| | | | 1.8 | |
| | | | 1.7 | |
| | | | 1.5 | |
| | | | 1.4 | |
| | | 40 | 3.3 | 4.2 |
| | | | 2.5 | |
| | | | 2.2 | |
| | | | 2.0 | |
| | | | 1.8 | |
| | | | 1.7 | |
| | | | 1.5 | |
| | | | 1.4 | |
| Comparative | 90 | 5 | 3.3 | 4.2 |
| Example 4 | | | 2.5 | |
| | | | 2.2 | |
| | | | 2.0 | |
| | | | 1.8 | |
| | | | 1.7 | |
| | | | 1.5 | |
| | | | 1.4 | |

| | Negative Electrode Capacity at | Charge/Discharge | | |
|---|---|---|---|---|
| | Charge Cut-off Voltage | Range with respect to | 100th Cycle | 200th Cycle |
| | (%, with respect to | Negative Electrode | Capacity | Capacity |
| | Negative Electrode | Theoretical Capacity | Retention | Retention |
| | Theoretical Capacity) | (%) | (%) | (%) |
| Example 8 | 30 | 10-40 | 92.1 | 87.1 |
| | 40 | 10-50 | 96.0 | 88.3 |
| | 45 | 10-55 | 97.0 | 87.8 |
| | 50 | 10-60 | 97.5 | 85.0 |
| | 55 | 10-65 | 96.1 | 79.0 |
| | 60 | 10-70 | 95.9 | 76.4 |
| | 65 | 10-75 | 94.1 | 69.8 |
| | 70 | 10-80 | 90.7 | 63.3 |
| | 30 | 20-50 | 95.7 | 91.6 |
| | 40 | 20-60 | 97.3 | 92.9 |
| | 45 | 20-65 | 96.3 | 92.1 |
| | 50 | 20-70 | 96.9 | 93.0 |
| | 55 | 20-75 | 97.4 | 93.2 |
| | 60 | 20-80 | 97.1 | 91.6 |
| | 65 | 20-85 | 97.5 | 84.2 |
| | 70 | 20-90 | 96.1 | 79.0 |
| | 30 | 30-60 | 92.6 | 87.8 |
| | 40 | 30-70 | 94.2 | 90.0 |
| | 45 | 30-75 | 94.2 | 91.8 |
| | 50 | 30-80 | 94.3 | 93.1 |
| | 55 | 30-85 | 93.8 | 93.6 |
| | 60 | 30-90 | 92.7 | 92.2 |
| | 65 | 30-95 | 93.6 | 80.7 |
| | 70 | 30-100 | 93.2 | 64.9 |
| Comparative | 30 | −5-25 | 92.0 | 69.9 |
| Example 4 | 40 | −5-35 | 91.1 | 70.9 |
| | 45 | −5-40 | 91.9 | 70.6 |
| | 50 | −5-45 | 88.8 | 65.5 |
| | 55 | −5-50 | 87.7 | 65.8 |
| | 60 | −5-55 | 89.7 | 68.0 |
| | 65 | −5-60 | 84.2 | 68.0 |
| | 70 | −5-65 | 83.4 | 59.0 |

### Example 9

A battery fabricated in the same manner as in Example 8 except for replacing LiCO_{l/3}Ni_{1/3}Mn_{1/3}O₂ with LiCO₂O₂ was subjected to charge/discharge cycles to determine capacity retentions in the same manner as in Example 8. The results are shown in Table 3 below.

### Example 10

A battery fabricated in the same manner as in Example 8 except for replacing LiCo_{1/3}Ni_{1/3}Mn_{1/3}O₂ with Li(Li_{0.03}Mn_{0.06} Co_{0.91})O₂ was subjected to charge/discharge cycles to determine capacity retentions in the same manner as in Example 8. The results are shown in Table 3.

TABLE 3

| | Preliminary Charge | | | |
|---|---|---|---|---|
| | Li Supply | Irreversible Capacity | | |
| | with respect to | with respect to | | |
| | Negative Electrode | Negative Electrode | | Charge |
| | Theoretical Capacity | Theoretical Capacity | Negative/Positive Electrode | Cut-off |
| | (%) | (%) | Capacity Ratio | Voltage (V) |
| Example 9 | 70 | 40 | 2.0 | 4.2 |
| | 90 | 20 | 2.0 | |
| | 90 | 40 | 2.0 | |
| Example 10 | 90 | 20 | 1.7 | 4.2 |
| | 90 | 40 | 1.7 | |

| | Negative Electrode Capacity | Charge/Discharge Range | | |
|---|---|---|---|---|
| | at Charge Cut-off Voltage | with respect to | 100th Cycle | 200th Cycle |
| | (%, with respect to | Negative Electrode | Capacity | Capacity |
| | Negative Electrode | Theoretical Capacity | Retention | Retention |
| | Theoretical Capacity) | (%) | (%) | (%) |
| Example 9 | 50 | 30-80 | 88.1 | 81.5 |
| | 50 | 10-60 | 87.3 | 81.1 |
| | 50 | 30-80 | 89.3 | 63.4 |
| Example 10 | 60 | 10-70 | 91.1 | 74.7 |
| | 60 | 30-90 | 91.0 | 85.8 |

The results in Tables 2 and 3 demonstrate that batteries assembled in accordance with the invention have increased capacity retention when preliminary charge and subsequent charge/discharge cycles are performed under the conditions according to the invention. The reason why the negative electrode used in Examples 8 to 10 was prepared by first preliminarily charging a battery composed of a negative electrode and a metallic lithium counter electrode and then disassembling the battery to take out the negative electrode is that the preliminary charging according to the present invention and the subsequent charge/discharge cycles are to be performed independently of each other. Therefore, such procedures including disassembling are not essential to the invention.

### INDUSTRIAL APPLICABILITY

The nonaqueous secondary battery of the invention is able to take full advantage of the high capacity characteristics possessed by the negative electrode active material and thereby has a prolonged life.

1. A nonaqueous secondary battery comprising a positive electrode which has a positive electrode active material layer containing Li(LiₓMn₂ₓCO₁₋₃ₓ)O₂ wherein x represents 0<x<⅓, and a negative electrode which has a negative electrode active material layer containing Si or Sn.

2. The nonaqueous secondary battery according to claim 1, wherein the negative electrode active material layer contains particles of a Si- or Sn-containing active material,
the particles are coated at least partially with a coat of a metallic material having low capability of forming a lithium compound, and
the active material layer has voids formed between the metallic material-coated particles.

3. The nonaqueous secondary battery according to claim 1, wherein the negative electrode active material layer contains particles of a Si- or Sn-containing active material and further contains particles of an electroconductive carbon material or a metallic material, and all of these particles are in a mixed state in the active material layer.

4. The nonaqueous secondary battery according to claim 2, wherein the metallic material is present on the surface of the particles over the entire thickness of the negative electrode active material layer.

5. The nonaqueous secondary battery according to claim 2, wherein the particles are coated with the coat of the metallic material which is formed by electroplating in a plating bath having a pH of 7.1 to 11.

6. The nonaqueous secondary battery according to claim 5, wherein the plating bath is a copper pyrophosphate bath having a weight ratio of P₂O₇ to Cu (P₂O₇/Cu) of 5 to 12.

7. The nonaqueous secondary battery according to claim 1, wherein the negative electrode active material layer has a void fraction of 15% to 45% by volume.

8. The nonaqueous secondary battery according to claim 1, wherein amounts of the positive electrode active material and the negative electrode active material are such that the ratio of the theoretical capacity of the negative electrode to the capacity of the positive electrode at a cut-off voltage in a charging operation which is performed after preliminary charge is 1.1 to 10, and lithium of an amount corresponding to 9% to 50% of the theoretical capacity of the negative electrode is accumulated in the negative electrode.

9. A method of conditioning the nonaqueous secondary battery according to claim 1, comprising performing preliminary charge that is a first charging operation after battery assembly at a higher cut-off voltage than a cut-off voltage for charging the battery after the preliminary charge.

10. The method according to claim 9, wherein the preliminary charge is performed at a cut-off potential of 4.4 V or higher vs. Li/Li⁺.

11. The method according to claim 9, wherein, in the secondary battery, amounts of the positive electrode active material and the negative electrode active material are such that the ratio of the theoretical capacity of the negative electrode to the capacity of the positive electrode at a cut-off voltage in a charging operation which is performed after the preliminary charge is 1.1 to 3.0, and
the preliminary charge is performed at a higher cut-off voltage than a cut-off voltage for charging the battery after the preliminary charge to accumulate in the negative electrode an irreversible capacity corresponding to 9% to 50% of the theoretical capacity of the negative electrode.

12. A method of conditioning a nonaqueous secondary battery, wherein the battery contains a positive electrode active material and a negative electrode active material in such amounts that the ratio of the theoretical capacity of the negative electrode to the capacity of the positive electrode at a cut-off voltage in a first and subsequent charging operations is 1.1 to 3.0 and the battery is adapted to be subjected to charge and discharge cycles such that the negative electrode capacity at the cut-off voltage in the first and subsequent charging operations is in the range of from 0% to 90% of the theoretical capacity of the negative electrode; and
wherein the method comprises supplying to the negative electrode lithium of an amount corresponding to 50% to 90% of the theoretical capacity of the negative electrode prior to the charge and discharge cycles.

13. The method according to claim 12, wherein preliminary charge is performed prior to the charge and discharge cycles to supply the amount of lithium from the positive electrode to the negative electrode so that an irreversible capacity corresponding to 9% to 50% of the theoretical capacity of the negative electrode remains in the negative electrode.

14. The method according to claim 12, wherein the positive electrode active material contains a lithium-transition metal complex oxide.
